(19) United States
(12) Patent Application Publication
(10) Pub. No.: US 2011/0146266 A1
(43) Pub. Date: Jun. 23, 2011

(54) DEVICE FOR COOLING A COOLANT, CIRCUIT FOR CHARGING AN INTERNAL COMBUSTION ENGINE, AND METHOD FOR COOLING A SUBSTANTIALLY GASEOUS CHARGING FLUID FOR CHARGING AN INTERNAL COMBUSTION ENGINE

(76) Inventors: Marcus Weinbrenner, Gerlingen (DE); Andreas Kemle, Tamm (DE); Ottokar Kunberger, Korntal-Munchingen (DE); Thomas Strauss, Notzingen (DE); Bernd Schäfer, Stuttgart (DE)

(21) Appl. No.: 12/970,856

(22) Filed: Dec. 16, 2010

Related U.S. Application Data
(63) Continuation of application No. PCT/EP2009/003861, filed on May 29, 2009.

(30) Foreign Application Priority Data
Jun. 16, 2008 (DE) 10 2008 028 290.1

(51) Int. Cl. F02B 29/04; F25B 41/00; F25B 41/04

(52) U.S. Cl. 60/599; 62/513; 62/196.1; 62/222; 62/197; 62/79

(57) ABSTRACT

A device for cooling a coolant, for cooling a charging fluid for charging an internal combustion engine is provided that includes a refrigerant guide, particularly a refrigerant circuit, and a coolant guide, particularly a coolant circuit; wherein the refrigerant guide comprises a first evaporator for a refrigerant for cooling an ambient air and a second evaporator for a refrigerant for cooling the coolant, the coolant guide comprises a heat exchanger for the charging fluid, a coolant cooler, and the second evaporator for the refrigerant of the refrigerant guide for cooling the coolant. In a first variant, the first and the second evaporator are disposed in series in the refrigerant guide. In a second variant, the first evaporator and the second evaporator are disposed in parallel in the refrigerant guide, particularly wherein a suction throttle is disposed downstream in the refrigerant flow after the second evaporator. A refrigerant bypass for the first and/or second evaporator serves for controlling the performance of the first and/or second evaporator.

This nonprovisional application is a continuation of International Application No. PCT/EP2009/003861, which was filed on May 29, 2009, and which claims priority to German Patent Application No. DE 10 2008 028 290.1, which was filed in Germany on Jun. 16, 2008, and which are both herein incorporated by reference.

### BACKGROUND OF THE INVENTION

1. Field of the Invention

The present invention relates to a device for cooling a coolant that is provided for cooling a charging fluid for charging an internal combustion engine, having a refrigerant path and a coolant path; wherein the refrigerant path has a first evaporator for a refrigerant for cooling an ambient air and has a second evaporator for a refrigerant for cooling the coolant; the coolant path has a heat exchanger for the charging fluid, a radiator, and the second evaporator for a refrigerant of the refrigerant path for cooling the coolant. The invention further concerns a circuit for charging an internal combustion engine, having a compressor in a flow path provided for the charging fluid and a heat exchanger for the charging fluid. The invention further concerns a method for cooling a substantially gaseous charging fluid provided for charging an internal combustion engine.

2. Description of the Background Art

A charging of internal combustion engines with cooled charging fluid, in particular a substantially gaseous charging fluid, for example a charge air and/or an exhaust gas or mixtures containing a charge air and/or an exhaust gas, is used in vehicles for reasons including legal requirements in order to reduce emissions of particulates and pollutants, in particular nitrogen oxide emissions. Since the requirements for exhaust gas cleanliness are becoming more stringent, charging systems are called upon to handle greater exhaust gas mass flows. Moreover, a specific engine output per unit of displacement can be increased for the case that one is able to design previously employed charging systems with a smaller space requirement, known as “downsizing.” Fuel can be saved by downsizing as well as by additional cooling of a charging fluid. By this means, namely, the charging fluid is supplied to the combustion process with a relatively cool temperature, which is associated with a gain in density of the charging fluid and hence permits better cylinder filling at reduced combustion temperatures. As a result, the charging fluid can be compressed more highly in the internal combustion engine, which results in the aforementioned reduction in fuel consumption or increase in output. In contrast, if the cooling of the charging fluid is inadequate due to adverse influences, cylinder filling takes place that is poorer by comparison, and hence the limit temperatures are reached more quickly, as is a resultant lower compression in the internal combustion engine. The result is a sensitive reaction of fuel consumption with lower output of the internal combustion engine.

Hence, it is known both in the field of diesel engines for commercial vehicles and the field of gasoline engines to provide two-stage intercoolers for improving cooling output when cooling a charging fluid. Such systems for commercial vehicles are described, for example, in WO2005/111392 A1, which corresponds to U.S. Pat. No. 7,806,091, and in EP 0 496 085 A1. Other two-stage cooling systems suitable for motor vehicles are described in EP 1 432 907 B1 (which corresponds to U.S. Pat. No. 7,104,062), EP 1 445 454 A1, and EP 0 678 661 B1 (which corresponds to U.S. Pat. No. 5,408,843 and U.S. Pat. No. 5,520,015). In these designs, charging fluid in a charging fluid circuit flows through two heat exchangers—a so-called high-temperature heat exchanger and a so-called low-temperature heat exchanger—which can be used as needed for cooling the charging fluid and are provided accordingly with one or more bypass passages for a charging fluid. Heat exchangers for charge air cooling can thus be arranged in a charge air channel as in DE 10 2004 045 661 A1, for example.

In addition to the abovementioned known methods for two-stage cooling of the charging fluid as such, a particularly effective cooling of the charging fluid is possible as described in DE 1 9859129 A1. In this solution, the charging fluid, which has been compressed by a compressor, is made to interact with coolant of the intercooler for cooling, and the coolant of the intercooler is in turn made to interact with a coolant/refrigerant evaporator of the air conditioner for cooling. A system of this nature has proven to need further improvement, since it works with only a single evaporator of the air conditioner. Accordingly, the applicant has proposed, for example in DE 1 0210132 A1 and DE 1 0254016 A1, a device of the initially mentioned type with a first evaporator in the form of a coolant/refrigerant evaporator and a second evaporator in the form of an air conditioning evaporator. In the refrigerant path, the coolant is expanded in an air conditioning evaporator for cooling an ambient air and is compressed in a compressor. The first evaporator in the form of the coolant/refrigerant evaporator and the second evaporator in the form of the air conditioning evaporator are connected in parallel in the refrigerant path. As a general rule, it has been demonstrated that such systems also react relatively sensitively.

A further improved concept for providing improved cooling output for a charging fluid using a first and a second evaporator for a refrigerant is therefore desirable.

### SUMMARY OF THE INVENTION

It is therefore an object of the present invention to provide a device for cooling a coolant that is provided for cooling a charging fluid for charging an internal combustion engine, as well as a circuit for charging an internal combustion engine. An additional object is to specify a method for cooling a substantially gaseous charging fluid provided for charging an internal combustion engine. The devices and the method are meant to be capable of more effectively providing charge fluid cooling output. In particular, effective utilization of the cooling output of the first and second evaporators is to be achieved even in different operating states of an internal combustion engine.

The object with regard to the device is attained by a device in which provision is made according to an embodiment of the invention that, in a first example, the first and second evaporators in the refrigerant path are arranged in a series arrangement, or, in a second example, the first evaporator and the second evaporator in the coolant path are arranged in a parallel arrangement, wherein a suction throttle is located downstream after the second evaporator with respect to the refrigerant flow.

The object concerning the circuit is attained by a circuit of the initially mentioned type in which is provided, according to the invention, a device according to the inventive concept that is coupled through the heat exchanger for the charging fluid.

A refrigerant path can be provided in the form of a refrigerant circuit. A coolant path can be provided in the form of a coolant circuit.

Interventions in the architecture of a refrigeration circuit and/or appropriate regulation of the refrigeration circuit make it possible to ensure both cooling of ambient air and cooling of the coolant in an improved manner even when output requirements differ. Within the scope of investigations, it has been determined that a first and a second evaporator operate at temperature levels that, if only slightly different, are still significantly different in individual cases. For example, a first evaporator for a refrigerant for cooling ambient air will generally operate at air temperatures between 20° C. and 70° C.—albeit perhaps only in the first minutes of a preferable cooling of a passenger compartment by the air conditioner. In contrast, a coolant inlet temperature for a second evaporator for a refrigerant for cooling the coolant will typically lie between 25° C. and 80° C. A long-time-average temperature level of the second evaporator thus tends to lie above that of a first evaporator, which leads to the need for an adapted architecture and/or regulation strategy for operating the device.

The invention has recognized that, in a first example, a series arrangement of the first and second evaporators, in contrast to a mere parallel arrangement of a first and second evaporator without additional measures as in the aforementioned prior art by the applicant, results in an improved architecture and capability for regulating the refrigerant circuit. Namely, it has become apparent that the aforesaid series arrangement for the first and second evaporators results in an approximately constant intake pressure environment, which can advantageously be managed by means of suitable actuating elements in order to actuate the first and/or second evaporator as needed. The combination of the two has the advantage that the problem of refrigerant displacement and oil circulation is minimized.

The invention has additionally recognized that, in a second example, a parallel arrangement of the first evaporator and the second evaporator in the refrigerant path, in particular together with the additional measure of locating a suction throttle downstream after the second evaporator with respect to the refrigerant flow, is superior to the prior art. In particular, it is made possible for the second evaporator to be at approximately equal intake pressure to the first evaporator as a result of the additional pressure drop accomplished by the suction throttle. As is recognized by the invention, a long-time average temperature level of the second evaporator tends to lie above that of the first evaporator. This has the result that an intake pressure at the second evaporator tends to lie above that of the first evaporator. In principle, any element that produces an additional pressure drop, for example by a reduced cross-section, in the part of the refrigerant path downstream with respect to the refrigerant flow after the second evaporator is suitable as a suction throttle effecting a pressure drop. This solution is possible because the pressure drop of the second evaporator, in particular a CAS evaporator, on the refrigerant side can be optimized without excessively affecting the performance of the cooling system. As a general rule this element can also be an expansion element/valve, such as an EXV or TXV, for example. The use of a suction throttle also advantageously permits the use of a TXV or similar expansion element in addition or alternatively. In general, a suction throttle proves to be more economical as compared to a switchover valve. A combination of suction throttle and shutoff valve proves to be advantageous, however. A simultaneous operating mode of the second evaporator and first evaporator results from the fact that a parallel-connected second evaporator and first evaporator are at relatively equal intake pressure levels due to the suction throttle. The concept of the invention leads to relatively equal evaporation temperatures and evaporation pressures in the two evaporators. In particular, the concept also has the advantage that the suction throttle, for example, can be adjusted such that a refrigerant that tends to be superheated is present, in order to avoid liquid components in the evaporated refrigerant, for example.

The concept of the invention explained above has shown itself to be applicable in especially advantageous fashion for a coolant circuit that is designed in the form of a low-temperature circuit. It is especially preferred in this design for a heat exchanger to be embodied in the form of an indirect intercooler and/or a radiator in the form of a low-temperature cooler. A coolant circuit preferably has a coolant pump as well as other appropriate means for conveying the coolant in the coolant path, in particular in the coolant circuit.

It has additionally proven to be especially preferred within the scope of the concept of the invention that a refrigerant circuit is configured for an air conditioner, and in particular additionally has a refrigerant compressor, a condenser, or gas cooler or the like, which is followed in a suitable fashion by a header and/or drier.

A first evaporator for a refrigerant in the form of an HVAC evaporator has proven to be especially preferred within the scope of the concept of the invention. A second evaporator for refrigerant in the form of a CAS evaporator has additionally proven to be especially preferred within the scope of the concept of the invention.

An internal combustion engine is preferably designed as a motor or combustion engine, preferably a gasoline engine. The implementation as a diesel engine is also possible.

In an embodiment, it has proven especially advantageous for the second evaporator to be located downstream of the first evaporator with respect to the refrigerant flow. In general, moreover, it is likewise possible as, an alternative for the first evaporator to be located downstream of the second evaporator with respect to the refrigerant flow. The first evaporator can be a CAS evaporator, and the second evaporator can be an HVAC evaporator.

For the purpose of regulating output of the first and/or second evaporator, provision can be made for the refrigerant path to have one refrigerant bypass each for the first and/or second evaporator. In particular, provision can be made that an actuating element for actuating the relevant refrigerant bypass is located downstream of the first and/or second evaporator with respect to the refrigerant flow. Each suitable actuating element can be, in particular, a switchover three-way valve and/or an arrangement of two shutoff valves, and/or a shutoff valve with an expansion element. Within the scope of the second variant, it has proven especially advantageous for a refrigerant bypass for the second evaporator to lead into the refrigerant path ahead of the suction throttle. For the case in which no pressure reduction is desired in bypass operation, it can be advantageous for the refrigerant bypass for the second evaporator to lead into the refrigerant path after the suction throttle. Overall, the aforementioned refinements of the invention, alone or in combination, make it possible within the scope of the invention to regulate or switch on or off the first and/or second evaporator, with the aforesaid advantages for matching the intake pressures of the two evaporators in accordance with needs and the operating state of the internal combustion machine.

Further, means can be provided in the device for an output measurement of the first and/or second evaporator. This can be accomplished using an air intake temperature and air quantity, for example.

An electrical and/or thermostatic expansion element, in particular with a shutoff function, can be located upstream of the first and/or second evaporator with respect to the refrigerant flow. Such means, and others, for regulating the output of the first and/or second evaporator have proven to be especially preferred. As a general rule, all output regulation means are suitable, e.g., using measurement of pressure and temperature of the refrigerant before and/or after the first and/or second evaporator.

The coolant path can have a sensor for ascertaining the coolant temperature. In advantageous manner, this measure permits the regulation of an alternating actuation of the first and second evaporator for the case in which an output demand on the first and second evaporator exceeds an output limit of the refrigerant path.

In an embodiment of the invention, a coolant bypass for the second evaporator can be provided in the coolant path. This proves to be advantageous for the inventive concept according to the first variant, and in particular for the second variant. It has been shown that an actuation of the coolant bypass for regulating the coolant temperature can serve to make the cooling output of the coolant path available to another system component, for example an electronic unit, as well as to the charge air. Such a situation can prove to be advantageous when the other system component, such as the electronics, for example, has an increased demand for cooling. In this regard, an intercooler in the form of a heat exchanger can, in effect, be disconnected by the coolant bypass on the coolant side. A compensation on the refrigerant side for regulating the coolant temperature can be achieved by means of the coolant path. This also has the advantage that a coolant path need not be designed for maximum demand, but instead the available cooling output of the refrigerant path can be taken into account in the design. In this regard, the coolant bypass can be used for indirect output regulation at the second evaporator, in particular a CAS evaporator. This indirectly permits output regulation of the charge air cooling. Through the coolant temperature, the refrigerant-side output at the second evaporator, in particular a charge air (CAS) evaporator, is indirectly regulated, since the evaporator pressure, and thus the refrigerant temperature, is influenced in this way. If the coolant temperature rises, then the refrigerant pressure, and consequently the refrigerant temperature, rises, and the refrigerant-side output at the CAS evaporator thus drops.

Further, the refrigerant bypass for the second evaporator can be actuated in a first operating state characterized by a coolant temperature that lies below a limit temperature. Alternatively, in such a device neither the refrigerant bypass for the second evaporator nor the refrigerant bypass for the first evaporator is actuated in a second operating state characterized by a coolant temperature above a limit temperature. In the latter alternative, both evaporators can be used for coolant cooling—if an output requirement of the first and second evaporators lies below an output limit of the refrigerant path. In the second alternative, the refrigerant bypass for the second evaporator and the refrigerant bypass for the first evaporator can be actuated in alternation—if an output requirement of the first and second evaporators lies above an output limit of the refrigerant path. The temperature signal of a sensor for determining the coolant temperature may be used as a measure for determining the operating state. In other respects, the aforementioned means for measuring and regulating output may be used in accordance with requirements and circumstances within the scope of the concept of the invention.

To attain the object of the invention with regard to the method for cooling a substantially gaseous charging fluid provided for charging an internal combustion engine, the invention provides a method according to the initially mentioned type, in which provision is made according to the invention that, in a first operating state characterized by a coolant temperature lying below a limit temperature, the refrigerant bypass for the second evaporator is actuated. Alternatively, according to the invention, either neither the refrigerant bypass for the second evaporator nor the refrigerant bypass for the first evaporator is actuated in a second operating state characterized by a coolant temperature lying above a limit temperature. Or, within the scope of the second alternative, it has proven advantageous that the refrigerant bypass for the second evaporator and the refrigerant bypass for the first evaporator are actuated in alternation, in particular for the case that an output requirement of the first and second evaporators lies above an output limit of the refrigerant path. Preferably the method is implemented with a device and/or a circuit of the type explained above.

It has preferable for a limit temperature to assume a value between 40° and 55° C., in particular between 40° and 50° C.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1: is a schematic view—pursuant to a first variant—of a first embodiment of a circuit for charging an internal combustion engine, which is not shown in detail, with a preferred device that is coupled according to the concept of the invention through a heat exchanger for the charging fluid;

FIG. 2: is a schematic view—pursuant to the first variant—of a second embodiment of a circuit for charging an internal combustion engine, which is not shown in detail, with a preferred device that is coupled according to the concept of the invention through a heat exchanger for the charging fluid;

FIG. 3: is a schematic view of a modified embodiment—pursuant to the first variant;

FIG. 4: is a schematic view—pursuant to a second variant—of a third embodiment of a circuit for charging an internal combustion engine, which is not shown in detail, with a preferred device that is coupled according to the concept of the invention through a heat exchanger for the charging fluid;

FIG. 5: is a schematic view—pursuant to the second variant—of a fourth embodiment of a circuit for charging an internal combustion engine, which is not shown in detail, with a preferred device that is coupled according to the concept of the invention through a heat exchanger for the charging fluid;

FIG. 6: is a schematic view—pursuant to the second variant—of a third embodiment modified with respect to FIG. 4;

FIG. 7: is a schematic view—pursuant to the second variant—of a fourth embodiment modified with respect to FIG. 5;

FIG. 8: is a schematic view of two modifications of a detail of the circuit from the first, second or third embodiment concerning the arrangement of a radiator and condenser with respect to the inflow of cooling air;

FIG. 9: is a logic diagram concerning the establishment of different operating states in a device according to the concept of the invention and/or within the scope of a method according to the concept of the invention for cooling a substantially gaseous charging fluid provided for charging an internal combustion engine;

FIG. 10: is a schematic representation of different operating states of the device within the scope of an especially preferred embodiment of a method as a function of a limit temperature of the coolant.

### DETAILED DESCRIPTION

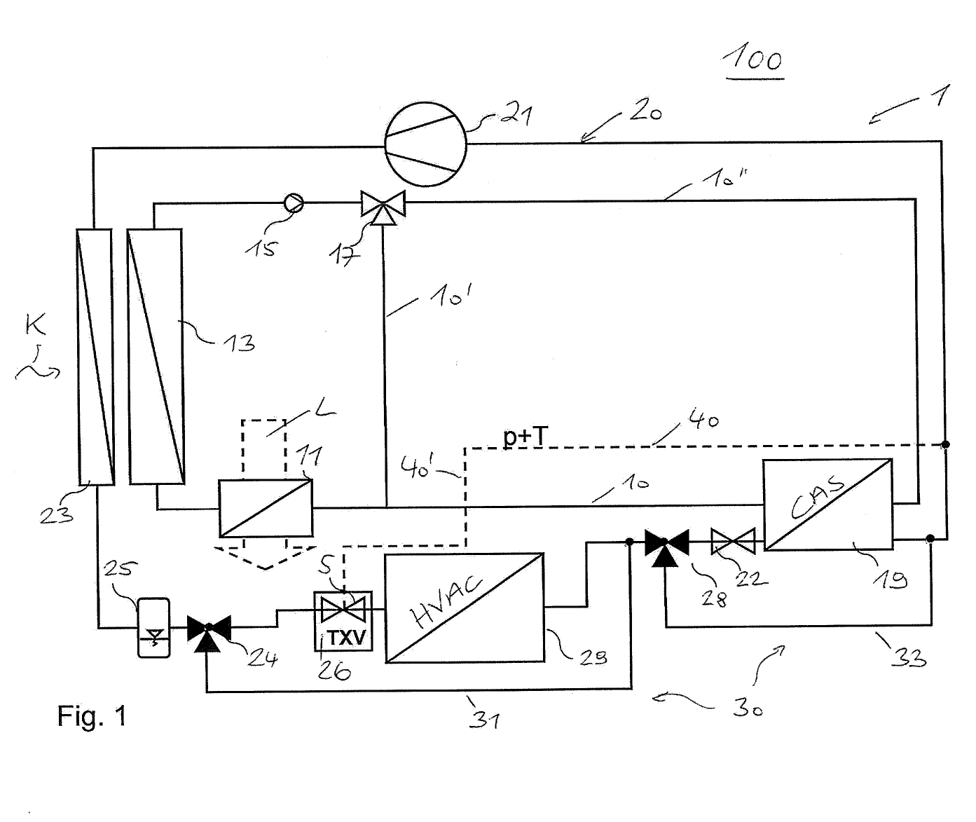

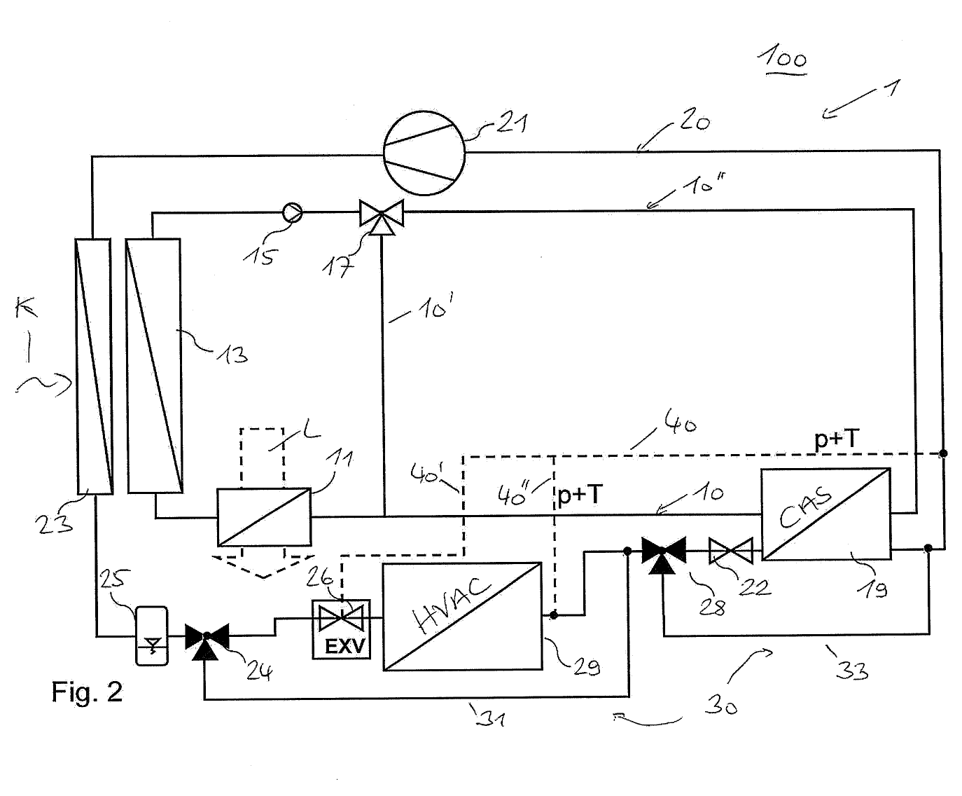

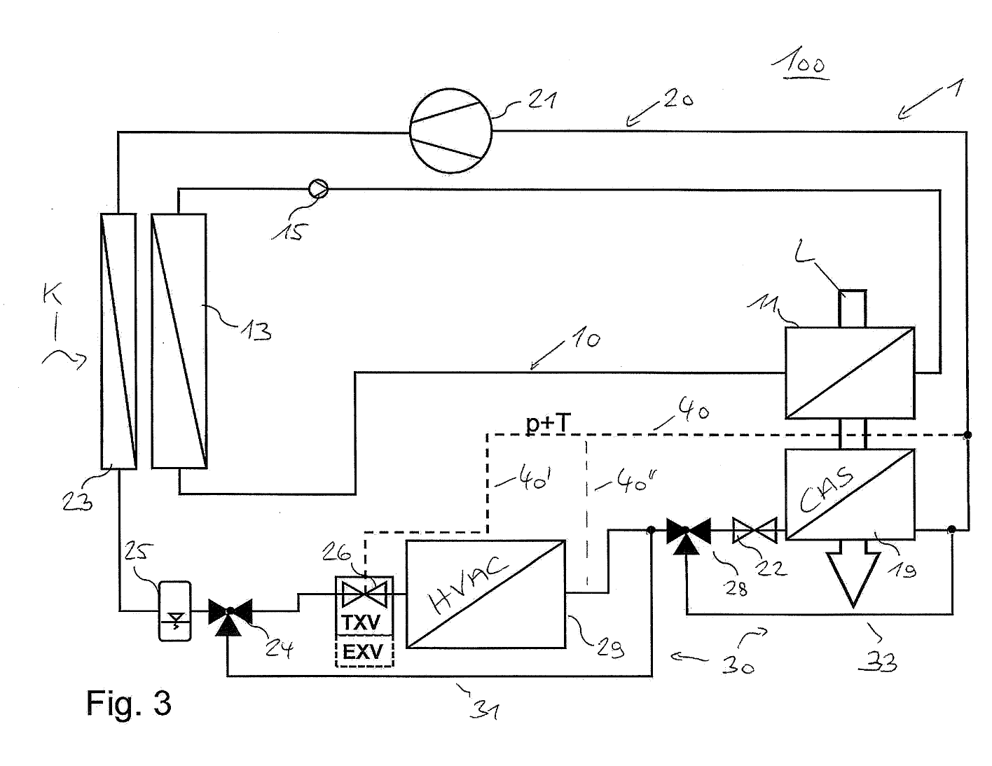

A circuit 100, represented symbolically in the present case, for charging an internal combustion engine, in particular a motor—preferably gasoline-fueled—with a charging fluid L has, according to the concept of the invention, a device 1 that is coupled through a heat exchanger 11 for the charging fluid L, and that is designed for cooling a coolant, which in turn is provided for cooling the charging fluid for charging the internal combustion engine. FIG. 1 through FIG. 3 show embodiments of the first variant, in which the first and second evaporators 29, 19 are connected in a series arrangement. FIG. 2 and FIG. 3 show additional variations of such a circuit 100, with a suitably modified device 1, wherein, for the sake of simplicity, the same reference symbols are used for identical parts or features, or parts or features having the same function. The charging fluid L can be understood to be, in particular, a substantially gaseous charging fluid—for example a charge air and/or an exhaust gas or mixtures containing a charge air and/or an exhaust gas. The present examples and embodiments are not restricted to a specific form of a charging fluid, but are indeed described using the example of a charging fluid L in the form of a charge air.

In the present case, the device 1 has a refrigerant path 20 in the form of a refrigerant circuit, and a coolant path 10 in the form of a coolant circuit.

The coolant path 10 is designed to conduct the coolant and has, in addition to the heat exchanger 11—to which charging fluid L and coolant can be applied—for cooling the charge air L, a radiator 13 located downstream of the heat exchanger 11 with respect to the coolant flow and also a coolant pump 15 located further downstream with respect to the coolant flow for circulating the coolant. The coolant is then directed by a three-way-valve 17 either to a bypass 10′ for direct return of the coolant to the heat exchanger 11, or is directed as needed to an additional coolant line section 10″ in order to direct the coolant to a CAS evaporator designated in the present case as the second evaporator 19. This evaporator is designed for further cooling of the coolant, and to this end can also have refrigerant applied to it; in other words, the second evaporator 19 in the form of a CAS evaporator couples the coolant path 10 and the refrigerant path 20. In the further course of the coolant path 10, the coolant is then transported onward to the aforementioned heat exchanger 11 for cooling the charging fluid L.

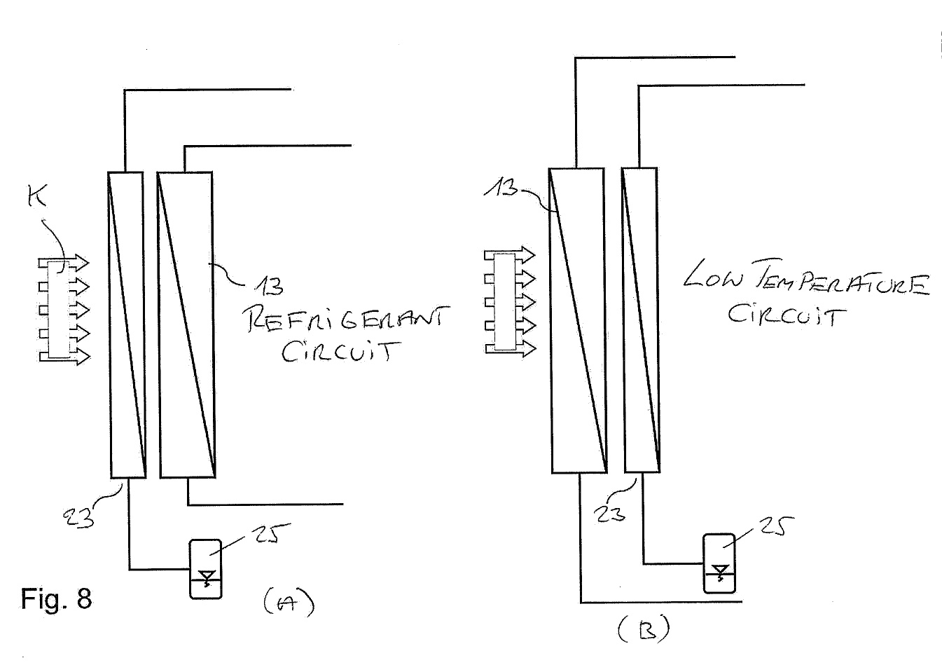

The refrigerant path 20 is designed to conduct a refrigerant, and accordingly has for this purpose a refrigerant compressor 21, which first delivers the refrigerant—which was substantially gaseous beforehand—to a condenser 23, which can also be designed as a gas cooler as needed. The arrangement of the condenser 23 and radiator 13 preferably is jointly subjected to the inflow of cooling air K in order to remove heat from the coolant and/or refrigerant and thereby cool or condense them. The arrangement of the condenser 23 and radiator 13 is varied in FIG. 8 in the views (A) and (B) and is described in detail as different variations.

The refrigerant is then transported in largely liquid form through the refrigerant path 20 to a receiver drier 25, which can also serve as a reservoir for the refrigerant. Then, for demand-based actuation of a first bypass 31, the refrigerant is routed by a first three-way valve 24, designed as a switchover valve, either through an expansion element 26—configured in the present case as a thermostatic expansion element TXV—to an evaporator for the refrigerant in the form of an HVAC evaporator, called the first evaporator 29, or else is returned in the bypass 31 to the original refrigerant path 20, avoiding the first evaporator 29. After this, the refrigerant is transported onward through a second three-way valve 28, designed as a switchover valve, either through a second expansion element 22 to the aforementioned first evaporator 19 in the form of a CAS evaporator, or, avoiding the same as needed, is transported through the second bypass 33 back to the original refrigerant path 20. The first evaporator 29 is provided for cooling ambient air, in the present case as part of an air conditioning system for cooling a passenger compartment. The evaporation of the refrigerant that occurs in the course of conducting the refrigerant through the expansion elements 26, 22 and the evaporators 29, 19 results in the further conveyance of the refrigerant in gaseous form through the refrigerant path 20, once again back to the refrigerant compressor 21, which in turn delivers the refrigerant to the condenser 23 to be liquefied.

The expansion elements 26, 22 can be designed as needed and, in particular, can be provided with a shutoff function that is not shown in detail, so that they are suitable for regulating the output of the first evaporator 19 or the second evaporator 29.

FIG. 2 shows an embodiment of a substantially identically constructed circuit 100 with a device 1 as was explained with reference to FIG. 1, with the difference that the first expansion element 26 in the present case is designed as an electrical expansion element EXV, while the first expansion element 26 of the device 1 in FIG. 1 is designed as a thermostatic expansion element TXV. In contrast to the device 1 in FIG. 1, the configuration of the expansion element 26 as an EXV permits the measurement of pressure and temperature of the refrigerant before and after the first evaporator 29, and hence an output regulation of the first evaporator 29 designed in accordance therewith. Among the advantages of this design is that an output at the evaporator 29 can be reduced in favor of the evaporator 19, which results in an increased output at the evaporator 19. In both FIG. 1 and FIG. 2, an appropriate measurement line 40 for a device 1 is coupled to the refrigerant path 20 downstream after the evaporators 29, 19 with respect to the refrigerant flow, and—in the case of the device 1 from FIG. 1—is connected to the first three-way valve 26 in the form of the TXV, and—in the case of the device 1 from FIG. 2—is connected to the first expansion element in the form of the EXV, and directly after the first evaporator 29 to the refrigerant path 20. The corresponding sections of the measurement line for pressure and temperature 40 are labeled 40′ and 40″.

FIG. 3 shows, in a single figure, the two embodiments from FIG. 1 and FIG. 2 in modified form, wherein the second embodiment from FIG. 2 is shown with the first expansion element in the form of the EXV and the additional section 40″ of the measurement line 40 is appropriately shown as a dotted line to illustrate that the additional modification of the device 1 shown in FIG. 3 can be implemented advantageously both for the embodiment from FIG. 1 and for the embodiment from FIG. 2. The modification of the device 1 in FIG. 3 makes provision that the heat exchanger 11 and the second evaporator 19 for the refrigerant for cooling the coolant in the form of a CAS evaporator can be implemented advantageously within the scope of a single constructional unit, through which the charging fluid L flows.

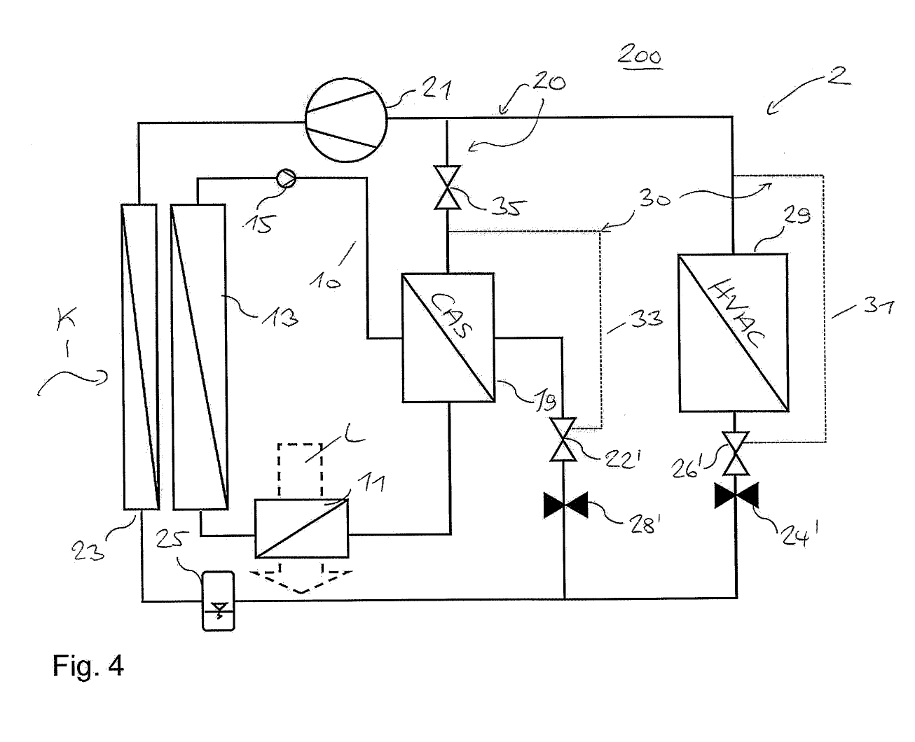

A circuit 200 symbolically represented in the present case in FIG. 4 through FIG. 7 is likewise intended for charging an internal combustion engine, in particular a motor, preferably gasoline-fueled, with a charging fluid L, as already explained with reference to FIG. 1 to FIG. 3. According to the concept of the invention, this circuit has a device 2 coupled through a heat exchanger 11 for the charging fluid L, which device is designed for cooling a coolant that in turn is provided for cooling the charging fluid for charging the internal combustion engine. FIG. 4 to FIG. 7 show embodiments of the second variant, in which the first and second evaporators 29, 19 are connected in a parallel arrangement. For the sake of simplicity, the same reference symbols are used in the text below for identical parts or features, or parts or features having the same function, even though the embodiments in FIG. 4 to FIG. 7 are devices 2 and circuits 200, which are configured differently from the devices 1 and circuits 100 in FIG. 1 to FIG. 3.

In the present case, a coolant path 10 is once again designed to conduct the coolant and has, in addition to the heat exchanger 11—to which charging fluid L and coolant can be applied—for cooling the charge air L, a radiator 13 located downstream of the heat exchanger 11 with respect to the coolant flow and also a coolant pump 15 located further downstream with respect to the coolant flow for circulating the coolant. For further cooling of the coolant, provision is made in the present embodiment of the device 2 for a circuit 200 that the full coolant mass flow is always directed through the second evaporator 19 in the form of a coolant/refrigerant evaporator, once again called a CAS evaporator. In the further course of the coolant path 10, the coolant is then transported onward to the aforementioned heat exchanger 11 for cooling the charging fluid L.

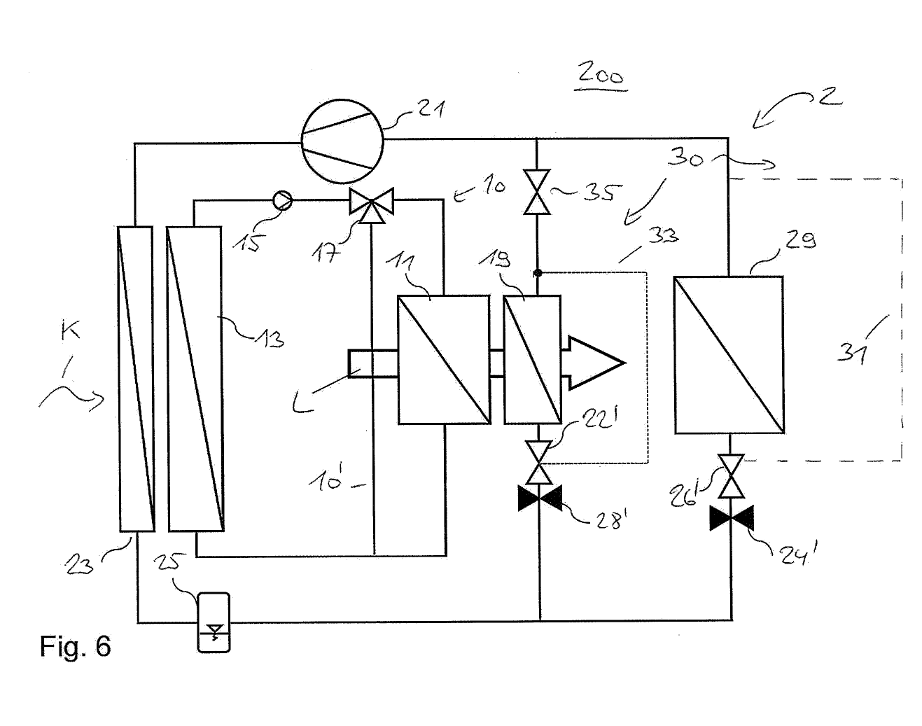

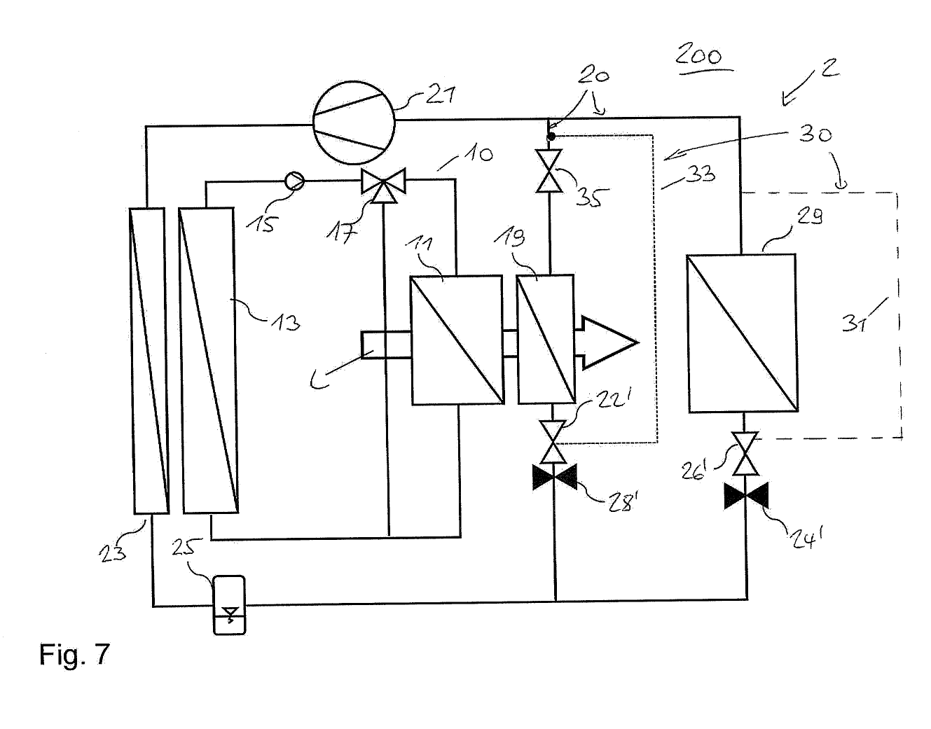

Additionally provided in the coolant path 10 according to FIG. 7, as was also the case in the embodiment from FIG. 6, is a coolant bypass 10′, switchable by means of the three-way valve 17, for the second evaporator 19 in the coolant path 10. The coolant bypass 10′ can be used on the coolant side for indirect output regulation at the second evaporator 19, in particular a CAS evaporator.

In the present case, the refrigerant path 20 is again designed to conduct a refrigerant, and accordingly has for this purpose a refrigerant compressor 21, which first delivers the refrigerant—which was substantially gaseous beforehand—to a condenser 23, which can also be designed as a gas cooler as needed. The arrangement of the condenser 23 and radiator 13 preferably is jointly subjected to the inflow of cooling air K in order to remove heat from the coolant and/or refrigerant and thereby cool or condense them. The arrangement of the condenser 23 and radiator 13 is modified in FIG. 8 in the views (A) and (B) and is described in detail as different variations.

The refrigerant is then transported in largely liquid form through the refrigerant path 20 to a receiver drier 25, which can also serve as a reservoir for the refrigerant. Then, based on the state of the shutoff valves 28′ and 24′, the refrigerant is routed as needed through a suitable expansion element 22′, 26′ to the second evaporator 19 in the form of the CAS evaporator and/or to the first evaporator 29 in the form of the HVAC evaporator. Both the second evaporator 19 and the first evaporator 29 can be bypassed in each case by means of a bypass 30. In the case of the first evaporator 29, the bypass 31 starts from the expansion element 26′ and again flows into the refrigerant path 20 downstream after the first evaporator 29 with respect to the refrigerant flow. In the case of the second evaporator 19, the bypass 33 starts from the expansion element 22′ and flows into the refrigerant path 20 downstream after the second evaporator 19 with respect to the refrigerant flow.

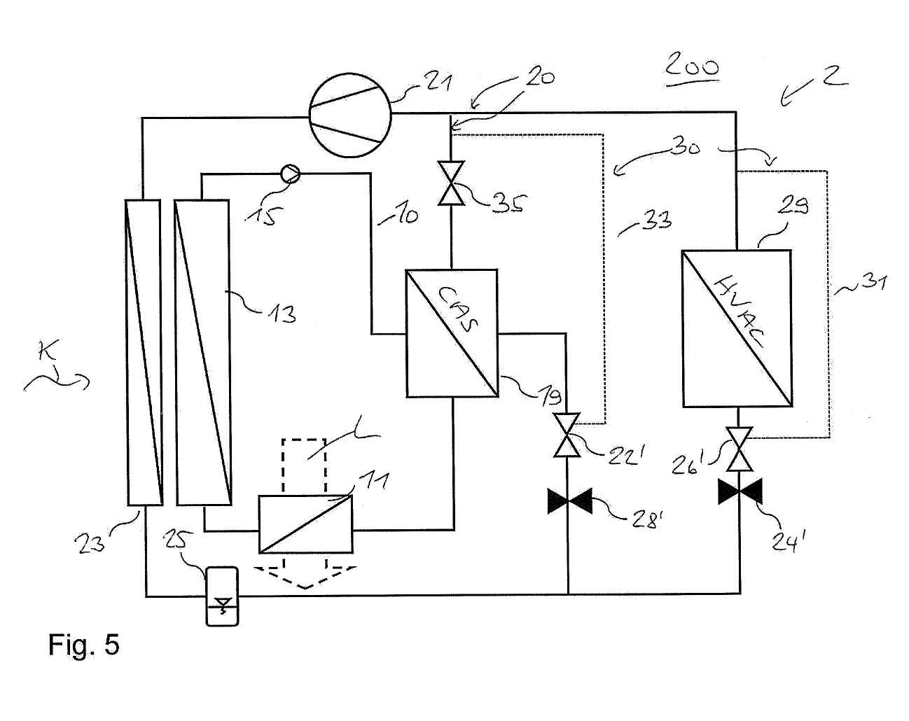

In a first embodiment of the second variant of the invention, FIG. 4 shows a device 2 in which the refrigerant bypass 33 of the second (CAS) evaporator 19 flows into the refrigerant path 20 downstream after the second evaporator 19 and ahead of a suction throttle 35 with respect to the refrigerant flow. FIG. 5 shows another second embodiment of a device 2, modified from said first embodiment, in which the refrigerant bypass 33 of the second evaporator 19 flows into the refrigerant path 20 after the aforementioned suction throttle 35—or, as explained at the outset, another appropriate element such as an EXV, for example—with the design otherwise being identical.

FIG. 6 and FIG. 7 show additional modified third and fourth embodiments of the second variant of the invention, which—in analogous manner to the third and fourth embodiments of the second variant—are designed with the variation that, in a similar manner to that already explained above for the embodiment of the first variant of the invention in FIG. 3, the heat exchanger 11 and the second evaporator 19 for the refrigerant for cooling the coolant are advantageously implemented in the form of a CAS evaporator within the scope of a single constructional unit, through which the charging fluid L flows.

As a general rule, however, it is also possible in FIG. 6 and FIG. 7 to arrange the heat exchanger 11 separately from the second evaporator 19 in a section downstream with respect to the coolant flow after the return of the coolant bypass 10′ to the coolant path 10 and ahead of the radiator 13.

In the third embodiment in FIG. 6, a refrigerant bypass 33 can be provided, but this is not required. In particular, the refrigerant bypass 33 in this design would flow into the refrigerant path 20 downstream after the second evaporator 19 with respect to the refrigerant flow and ahead of the suction throttle 15. In FIG. 7 in the fourth embodiment of the second variant of the invention, the refrigerant bypass 33 flows into the refrigerant path 20 after the suction throttle 35.

Based on the third and fourth embodiments of the second variant of the invention, as shown in FIG. 4 to FIG. 7, it is once again possible, this time even in a parallel arrangement of the second evaporator 19 and the first evaporator 29, to operate the two evaporators at approximately equal intake pressure. The intake pressure of the second evaporator 19 (CAS evaporator) is reduced in advantageous fashion by the suction throttle 35.

The additional operation of the second evaporator 19 is a goal in the present design in particular for the case where the coolant temperature is greater than 40° C. to 55° C. In this case, the shutoff valve 28′ for the second evaporator 19 opens, and refrigerant flows through the evaporator. Due to the high coolant mass flow, the temperature difference of the coolant over the second evaporator 19 is 5° C. to 10° C.; the coolant outlet temperature in the present design is then approximately 30° C. to 55° C., depending on the intake temperature. Since the temperature levels of the two evaporators 19, 29 are very different in this respect, the intake pressure level of the first evaporator 29 and the second evaporator 19 are configured differently by means of the suction throttle 35, in accordance with the concept of the second variant of the invention. In the present case, the suction throttle 35 is integrated into the header pipe of the second evaporator 19, downstream in the refrigerant path 20 with respect to the refrigerant flow. An expansion element 22′—in the present case, in the form of a thermal expansion valve, for example—regulates the superheating after the suction throttle 35. In this way, a standard TXV (thermal expansion valve) can be used, for example.

The pressure drop in the second evaporator 19 on the refrigerant side is not very critical in this case, since it can be offset against the suction throttle pressure drop. In a modified variation, the suction throttle 35 can also be designed as an electrically controlled expansion valve or proportional valve. In this way, the suction throttle 35 can be combined with the shutoff valve 28′. This last measure results in saving an additional valve.

In addition, FIG. 8 shows in views (A) and (B) two possible variations for the arrangement of a condenser 23 and radiator 13 relative to one another, which are suitable for both variants of the invention. In the variants of a coolant circuit in a coolant path 10 that are explained above and can be implemented to particular advantage in the scope of FIG. 8, the coolant circuit is advantageously implemented as a low-temperature circuit. The heat exchanger 11 is advantageously implemented as an indirect intercooler. Accordingly, the radiator 13 is implemented in advantageous manner as a low-temperature cooler. View (A) of FIG. 8 shows the arrangement of the radiator 13 and the condenser 23 as it has been shown in the above-described FIG. 1 to FIG. 7. This arrangement has proven to be especially advantageous for designing the refrigerant path 20, since in this arrangement the cooling air K first flows past the condenser 23 and thereby preferentially cools the refrigerant. In the arrangement of a condenser 23 and a radiator 13 shown in view (B) of FIG. 8, the cooling air first flows past the radiator 13, so that this arrangement proves to be especially advantageous for heat-removing relief of the coolant path 10. This modification can also be used as needed in a device 1 from FIG. 1 to FIG. 7.

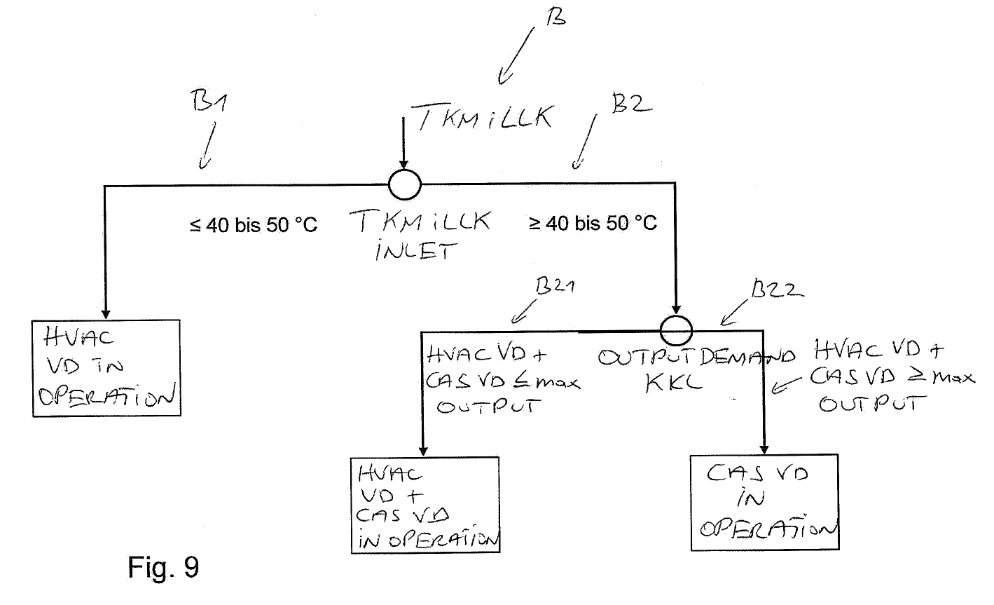

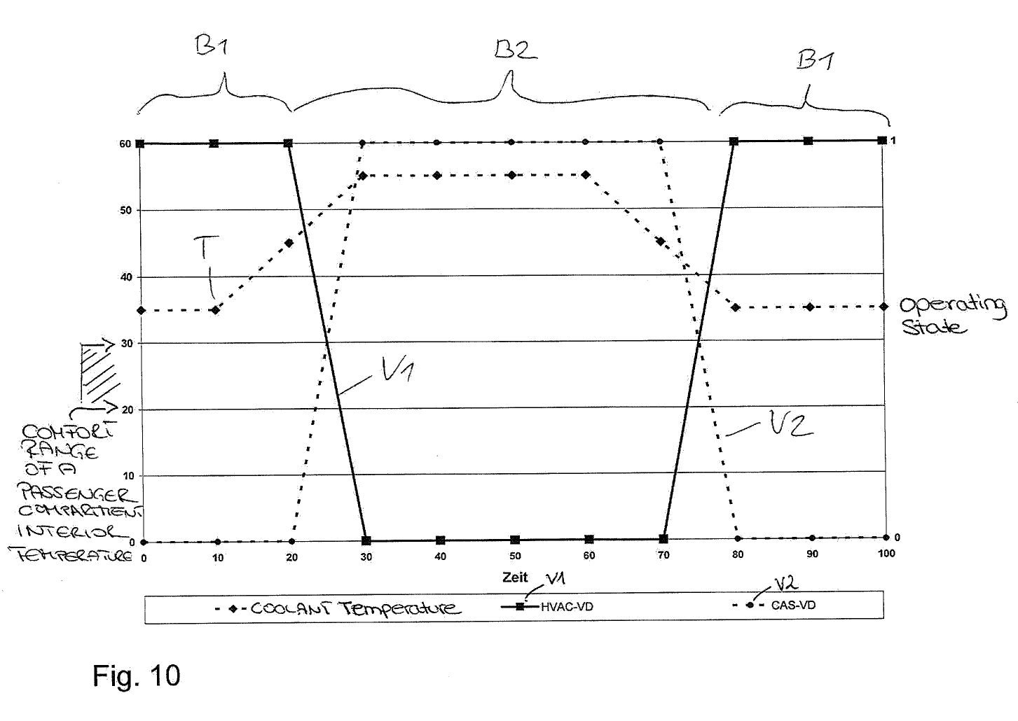

A switchover valve 17 on the coolant side has proven to be advantageous for actuating the coolant-side bypass 10′ in the above-described manner, in order to avoid and thereby indirectly regulate the second evaporator 19. A switchover valve 28 or shutoff valve 29′ has also proven especially advantageous for shutting off the second evaporator 19 in the form of a CAS evaporator. This causes a reduction in the pressure drop on the coolant side and consequently a lower power consumption of the coolant pump 15, ultimately resulting in a savings in fuel. Moreover, the second evaporator in the form of the CAS evaporator can also be kept “cold” by a comparatively small mass flow on the refrigerant side, for example through a designed-in intentional leakage of the expansion element, in order to rapidly provide cooling output in case of need on account of the low temperature level of the mass, which is to say the stored “cold.” This is explained in detail with reference to the following FIG. 9 and FIG. 10 for explaining an operating strategy of the above-described embodiments of a device 1, 2 and a circuit 100, 200. Overall, through the advantageous use of the aforementioned shutoff valves 24, 24′, 28, 28′ and/or expansion elements 26, 26′, 22, 22′ ahead of the two evaporators 29, 19, each of the evaporators 29, 19 can be operated individually or in alternation, depending on what output requirement and response characteristics exist for the refrigerant circuit and what coolant displacement is provided.

The embodiments of a device 1, 2 explained above are not restrictive. Rather, additional implementations of a device according to the concept of the invention as claimed are also suitable. For example, in an embodiment of the first variant of the invention that is not shown here, the second evaporator implemented as a CAS evaporator can also be arranged in series ahead of the first evaporator implemented as an HVAC evaporator. In a further modification, an arrangement of two shutoff valves can be provided for actuating each of the bypass sections 30 in place of the three-way valves 24, 28. Lastly, as already explained in part, an expansion element in the form of an EXV or TXV can optionally be arranged in place of the expansion elements 26, 26′, 22, 22′.

Overall, these and other advantageous implementations of a device 1, 2, especially in conjunction with the operating strategy explained below, permit a fuel savings and an increase in output in a relatively large operating range. The operation of the refrigerant circuit 20 with both evaporators 29, 19 turns out to be comparatively reliable, and permits an especially advantageous and demand-based distribution of the output flows and refrigerant mass flows. Thus, it is possible both to avoid icing, for example, and to always provide demand-based and sufficient output for the passenger compartment and engine.

A method for cooling a substantially gaseous charging fluid provided for charging an internal combustion engine with an above-described circuit 100, 200 for charging an internal combustion engine is represented in an especially preferred embodiment in FIG. 9 as a logic flow diagram, and in FIG. 10 with associated temperature curves for a coolant temperature T and an operating state V1 for a first evaporator 29—which symbolizes the activity of the evaporator 29 in the form of the HVAC evaporator for cooling an ambient air or passenger compartment air (e.g., in recirculation operation)—and also in an operating state V2—which symbolizes the activity of a second evaporator 19 for a refrigerant for cooling the coolant in the form of the CAS evaporator. Overall, to this end provision is made that, in a first operating state B1 characterized by a coolant temperature lying below a limit temperature, the refrigerant bypass 33 for the second evaporator 19 is actuated. In the present case, the limit temperature is in a range from 40° to 50° C. In other words, the second evaporator 19 is inactive in this first operating state B1. The corresponding regions are identified with B1 in FIG. 10. In this operating state B1, which is also to be designated as normal operation, the coolant temperature preferably lies below the limit temperature of, e.g., 40° to 55° C. In concrete terms, the CAS evaporator, as the coupling element between the low-temperature cooling circuit and the refrigerant circuit, is not connected or is completely bypassed by the bypass 33, which is on the refrigerant side in this design, actuated by the three-way valve 28. In a variant or alternative modification, a coolant-side bypass can also be provided in order to not place demands on the additional cooling action of the second evaporator 19.

For embodiments from FIG. 1 to FIG. 3 in particular, output regulation of the first evaporator 29, here in the form of the HVAC evaporator, takes place in this case by means of an EXV and TXV as expansion element 26, and further by means of measurement of pressure and temperature of the refrigerant, in particular after the HVAC evaporator. As explained, the CAS evaporator is preferably bypassed by the refrigerant-side bypass 33 and an appropriate setting of the three-way valve 28. As a result of the three-way valve's coolant-side decoupling, the CAS evaporator as second evaporator 19 can be kept at a relatively low temperature level in an advantageous manner, similar to the temperature level of the HVAC evaporator as first evaporator 29. By establishing such a relatively small refrigerant mass flow, the low temperature level can be fostered further. This can be achieved by purposeful opening—for instance in the form of low-frequency pulsing—of the shutoff valve at the CAS evaporator as second evaporator 19, for example. Another possibility is to maintain a very small refrigerant mass flow as leakage by means of a defined geometry in the expansion element 22. As a result, when the need arises, i.e. when additional charge air cooling output is required, the second evaporator 19 as CAS evaporator is at a relatively low temperature level. Such a low temperature level has a certain buffering effect when the second evaporator 19 is turned on, and permits rapid cooling of the charge air—this takes place before the coolant circuit with the coupled-in CAS evaporator would normally have started up and be in steady-state operation. Moreover, this measure has the advantage that the power consumption of a coolant pump 15, regardless of whether it is an electric or conventional cooling pump, is reduced due to the elimination of the coolant-side pressure drop of the CAS evaporator. Thus, fuel consumption is reduced as a result.

In a second operating state B2 characterized by a coolant temperature lying above a limit temperature, two subsidiary operating states B21 and B22 are possible for cooling the charging fluid and, in concrete terms, for operating the first evaporator 29 and the second evaporator 19.

In a first subsidiary operating state B21, neither the refrigerant bypass 33 for the second evaporator 19 nor the refrigerant bypass 31 for the first evaporator 29 is actuated. In the case of the second variant of the invention, the shutoff valve 28′ for the second evaporator 29 opens, as already explained above. In other words, both evaporators 29, 19 are active. This subsidiary operating state is suitable for the case when an output requirement of the first and second evaporators 29, 19 lies below an output limit of the coolant path 10. In other words, for additional cooling of the coolant at a coolant temperature of, in the present case, greater than 40° C. to 55° C., the CAS evaporator in the low-temperature cooling circuit and coupled to the refrigerant circuit is connected in addition to the first evaporator 29 to provide additional cooling of the coolant. The first evaporator in the form of the HVAC evaporator thus remains connected when the output at the CAS evaporator and the output of the HVAC evaporator do not exceed the total output of the refrigerant circuit. The intake air temperature and air quantity, for example, can be used for the output of the individual evaporator 19, 29. This is known, for example, in an engine control unit and/or a climate control unit. Output regulation of the HVAC evaporator takes place by means of an EXV or TXV as explained above and/or by means of measurement of pressure and temperature of the refrigerant after the CAS evaporator. When an electrical expansion element 26 (EXV) is used on the HVAC evaporator, the output drawn from the HVAC evaporator can be varied according to the target value. The output of the CAS evaporator can be regulated directly only relatively poorly; instead, it is advantageously regulated indirectly through the HVAC evaporator.

When a thermostatic expansion element 26 (TXV) is used, the output drawn is established by setting the superheating as a function of the intake pressure. In this case, the setting is prioritized for the HVAC evaporator, so that the remaining output of the HVAC evaporator, which is to say the remaining unevaporated refrigerant, is available to the CAS evaporator. In parallel therewith, the refrigerant side output of the CAS evaporator can be set by the coolant side switchover valve in the form of the three-way valve—also known as a 3/2 way valve—by the means that a specific coolant mass flow, and hence a specific output draw by the coolant, takes place as a result of pulsing the valve 28 and 24.

In a subsidiary operating state B22, an output requirement for the first and second evaporator lies above an output limit of the refrigerant path, and the refrigerant bypass 33 for the second evaporator 19 and the refrigerant bypass 31 for the first evaporator 29 are actuated in alternation. In other words, this subsidiary operating state B22 corresponds to the case where the coolant temperature is greater than 40° C. to 55° C. and the output requirement becomes too high. While the CAS evaporator, as coupling element between low-temperature coolant circuit and the refrigerant circuit, is indeed connected for additional cooling of the coolant, an alternating operation of the two evaporators 19, 29 takes place on account of the excessively high output demand of the CAS evaporator on the coolant and/or refrigerant circuits. Turn-on and turn-off of the evaporators 19, 29 takes place by means of the above-described switchover valves 24, 28. An output regulation of the CAS evaporator takes place, for example, by means of an above-described conventional thermostatic expansion element 26 (TXV) or by means of a TXV with integrated shutoff function. At the same time, the first evaporator in the form of the HVAC evaporator is shut off or bypassed on the refrigerant side by means of a bypass line 31.

In summary, the invention concerns a device 1 for cooling a coolant that is provided for cooling a charging fluid for charging an internal combustion engine, having a refrigerant path 20, in particular a refrigerant circuit, and having a coolant path 10, in particular a coolant circuit, wherein the refrigerant path 20 has a first evaporator 29 for a refrigerant for cooling an ambient air, and has a second evaporator 19 for a refrigerant for cooling the coolant; the coolant path 10 has a heat exchanger 11 for the charging fluid L, has a radiator 13, and has the second evaporator 19 for the refrigerant of the refrigerant path 20 for cooling the coolant. According to the concept of the invention, provision is made in a first variant that the first and second evaporators 29, 19 in the refrigerant path 20 are connected in a series arrangement. In a second variant, provision is made that the first evaporator 29 and the second evaporator 19 in the refrigerant path 20 are in a parallel arrangement, wherein a suction throttle 35 is located downstream after the second evaporator 19 with respect to the refrigerant flow. Preferably, a refrigerant bypass 30, 31, 33 for the first and/or second evaporator 29, 19 serves to regulate the output of the first and/or second evaporator 29, 19.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for cooling a coolant that is provided for cooling a charging fluid for charging an internal combustion engine, the device comprising:
a refrigerant path or a refrigerant circuit, the refrigerant path having a first evaporator for a refrigerant for cooling an ambient air and a second evaporator for a refrigerant for cooling the coolant; and
a coolant path or a coolant circuit, the coolant path having a heat exchanger for the charging fluid, a radiator, and the second evaporator for the refrigerant of the refrigerant path for cooling the coolant,
wherein the first evaporator and the second evaporator in the refrigerant path are arranged in a series arrangement, or
wherein the first evaporator and the second evaporator in the refrigerant path are arranged in a parallel arrangement, whereby a suction throttle is arranged downstream of the second evaporator with respect to a refrigerant flow.

2. The device according to claim 1, wherein the second evaporator is located downstream of the first evaporator with respect to the refrigerant flow, or wherein the first evaporator is located downstream of the second evaporator with respect to the refrigerant flow.

3. The device according to claim 1, wherein the first evaporator and the second evaporator in the refrigerant path are arranged in a series arrangement and a suction throttle is located downstream after the first evaporator and/or the second evaporator with respect to the refrigerant flow.

4. The device according to claim 1, wherein, for regulating an output of the first and/or second evaporator, the refrigerant path has one refrigerant bypass for each of the first and/or second evaporator when the first evaporator and second evaporator are arranged in the series arrangement in the refrigerant path.

5. The device according to claim 1, wherein a refrigerant bypass for the second evaporator leads into the refrigerant path ahead of or after the suction throttle when the first evaporator and second evaporator are arranged in a parallel arrangement in the refrigerant path.

6. The device according to claim 1, wherein a coolant bypass for the second evaporator and/or the first evaporator is arranged in the coolant path.

7. The device according to claim 1, wherein an actuating element for actuating the refrigerant bypass is arranged upstream of the first and/or second evaporator with respect to the refrigerant flow, in each case being a switchover three-way valve and/or two shutoff valves, and/or one shutoff valve with an expansion element.

8. The device according to claim 1, further comprising a component for output measurement of the first and/or second evaporator.

9. The device according to claim 1, wherein an expansion element or an electrical and/or thermostatic expansion element with a shutoff function is arranged upstream of the first evaporator and/or the second evaporator with respect to the refrigerant flow for output regulation of the first evaporator and/or the second evaporator.

10. The device according to claim 1, wherein the coolant path has a sensor for ascertaining the coolant temperature.

11. The device according to claim 1, wherein, in a first operating state, when a coolant temperature is below a limit temperature, the refrigerant bypass for the second evaporator is actuated, or, wherein, in a second operating state, when a coolant temperature is above a limit temperature, either: neither the refrigerant bypass for the second evaporator nor the refrigerant bypass for the first evaporator is actuated or, in a case that an output requirement of the first and second evaporators lies above an output limit of the refrigerant path, the refrigerant bypass for the second evaporator and the refrigerant bypass for the first evaporator are actuated in alternation.

12. The device according to claim 1, wherein the heat exchanger and the second evaporator are implemented separately or in a common constructional unit, wherein the heat exchanger is arranged so that the charging fluid is flowable separately through it or is arranged with the second evaporator in a constructional unit such that the charging fluid flow there through.

13. A circuit for charging an internal combustion engine, the circuit comprising:
a compressor or an exhaust-driven turbocharger in a flow path of a charging fluid for a charging fluid; and
a device according to claim 1 coupled through the heat exchanger for the charging fluid.

14. A method for cooling a substantially gaseous charging fluid provided for charging an internal combustion engine, in particular a charge air and/or an exhaust gas or mixtures containing a charge air and/or an exhaust gas, having a circuit for charging the internal combustion engine according to claim 1,
wherein, in a first operating state, when a coolant temperature lies below a limit temperature, the refrigerant bypass for the second evaporator is actuated, or
wherein, in a second operating state, when a coolant temperature lies above a limit temperature, either: neither the refrigerant bypass for the second evaporator nor the refrigerant bypass for the first evaporator is actuated, or, when an output requirement of the first and second evaporators lies above an output limit of the refrigerant path, the refrigerant bypass for the second evaporator and the refrigerant bypass for the first evaporator are actuated in alternation.

15. The method according to claim 14, wherein the limit temperature lies between 40° and 55° C.

16. The method according to claim 14, wherein a coolant bypass is actuated for regulating the coolant temperature, in particular the coolant temperature is readjusted via the refrigerant path.
